(19) United States
(12) Patent Application Publication
(10) Pub. No.: US 2020/0042128 A1
(43) Pub. Date: Feb. 6, 2020

(54) ELECTRONIC WHITEBOARD SYSTEM, OPERATING METHOD THEREOF AND ELECTRONIC WHITEBOARD

(71) Applicant: Coretronic Corporation, Hsin-Chu (TW)

(72) Inventors: Chung-Lung Yang, Hsin-Chu (TW); Pen-Ning Kuo, Hsin-Chu (TW)

(73) Assignee: Coretronic Corporation, Hsin-Chu (TW)

(21) Appl. No.: 16/525,585

(22) Filed: Jul. 30, 2019

(30) Foreign Application Priority Data
Jul. 31, 2018 (CN) 201810856360.X

(51) Int. Cl. G06F 3/041; G06F 3/0354; G06F 3/0488; B43L 1/00

(52) U.S. Cl. CPC G06F 3/0412; B43L 1/00; G06F 3/04886; G06F 3/03547

(57) ABSTRACT

An electronic whiteboard system, an operating method and an electronic whiteboard are provided. The electronic whiteboard system includes an electronic whiteboard and an electronic device. The electronic whiteboard includes a functional area. The electronic device is coupled to the electronic whiteboard and includes a display. The electronic whiteboard receives a touch input to generate coordinate information corresponding to the touch input. The electronic whiteboard transmits the coordinate information to the electronic device. The electronic device receiving the coordinate information determines whether the coordinate information is located in the functional area of the electronic whiteboard. If yes, the electronic device executes a function corresponding to the coordinate information. If not, the electronic device displays the touch input corresponding to the coordinate information on the display. The electronic whiteboard system, the operating method and the electronic whiteboard of the invention are adapted to improve convenience and functionality of the electronic whiteboard.

### CROSS-REFERENCE TO RELATED APPLICATION

This application claims the priority benefit of China application serial no. 201810856360.X, filed on Jul. 31, 2018. The entirety of the above-mentioned patent application is hereby incorporated by reference herein and made a part of this specification.

### BACKGROUND OF THE INVENTION

### Field of the Invention

The invention relates to an electronic whiteboard system, an operating method thereof and an electronic whiteboard, and particularly relates to an electronic whiteboard system defining a functional area, an operating method thereof and an electronic whiteboard.

### Description of Related Art

Conventional whiteboards apply mark pens and erasers as writing and wiping tools to implement discussion and teaching. Components used in the conventional whiteboards include whiteboards, mark pens, and erasers. The whiteboard is a board where writing and wiping operations may be performed by using a mark pen and an eraser. The mark pen may generate handwriting on a general whiteboard. The eraser may wipe off the handwriting on the general whiteboard. However, a conventional teaching system using the whiteboard has the disadvantages that information is unable to digitize, the information is difficult to store, and the information is not easy to share, etc. Therefore, in recent years, product development and application of electronic whiteboards gradually become popular. How to improve the convenience and functionality of the electronic whiteboards has become a target that those skilled in the art should strive for.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The invention is directed to an electronic whiteboard system, an operating method thereof and an electronic whiteboard, which are adapted to improve convenience and functionality of the electronic whiteboard.

Other objects and advantages of the invention may be further illustrated by the technical features broadly embodied and described as follows.

In order to achieve one or a portion of or all of the objects or other objects, an electronic whiteboard system provided by an embodiment of the invention includes an electronic whiteboard including a functional area; and an electronic device coupled to the electronic whiteboard, where the electronic device includes a display. The electronic whiteboard receives a touch input to generate coordinate information corresponding to the touch input. The electronic whiteboard transmits the coordinate information to the electronic device. The electronic device receiving the coordinate information determines whether the coordinate information is located in the functional area of the electronic whiteboard. When the coordinate information is located in the functional area of the electronic whiteboard, the electronic device executes a function corresponding to the coordinate information. Alternatively, when the coordinate information is located outside the functional area of the electronic whiteboard, the electronic device displays the touch input corresponding to the coordinate information on the display.

In order to achieve one or a portion of or all of the objects or other objects, an electronic whiteboard system provided by an embodiment of the invention includes an electronic whiteboard including a functional area; and an electronic device coupled to the electronic whiteboard, where the electronic device includes a display. The electronic whiteboard receives a touch input to generate coordinate information corresponding to the touch input. The electronic whiteboard determines whether the coordinate information is located in the functional area of the electronic whiteboard. When the coordinate information is located in the functional area of the electronic whiteboard, the electronic whiteboard transmits a command corresponding to the coordinate information to the electronic device, and the electronic device receiving the command executes a function corresponding to the command. Alternatively, when the coordinate information is located outside the functional area of the electronic whiteboard, the electronic whiteboard transmits the coordinate information to the electronic device, and the electronic device receiving the coordinate information displays the touch input corresponding to the coordinate information on the display.

In order to achieve one or a portion of or all of the objects or other objects, an operating method provided by an embodiment of the invention includes: receiving a touch input by an electronic whiteboard and generating coordinate information corresponding to the touch input; transmitting the coordinate information to an electronic device by the electronic whiteboard; determining whether the coordinate information is located in a functional area of the electronic whiteboard by the electronic device receiving the coordinate information; and when the coordinate information is located in the functional area of the electronic whiteboard, executing a function corresponding to the coordinate information by the electronic device, or when the coordinate information is located outside the functional area of the electronic whiteboard, displaying the touch input corresponding to the coordinate information on the display by the electronic device.

In order to achieve one or a portion of or all of the objects or other objects, an operating method provided by an embodiment of the invention includes: receiving a touch input by an electronic whiteboard and generating coordinate information corresponding to the touch input; determining whether the coordinate information is located in a functional area of the electronic whiteboard by the electronic whiteboard; and when the coordinate information is located in the functional area of the electronic whiteboard, transmitting a command corresponding to the coordinate information to the electronic device by the electronic whiteboard, and executing a function corresponding to the command by the electronic device receiving the command, or when the coordinate information is located outside the functional area of the electronic whiteboard, transmitting the coordinate information to the electronic device by the electronic whiteboard, and displaying the touch input corresponding to the coordinate information on the display by the electronic device receiving the coordinate information.

In order to achieve one or a portion of or all of the objects or other objects, an embodiment of the invention provides an electronic whiteboard coupled to an electronic device having a display. The electronic whiteboard includes a functional area. The electronic whiteboard receives a touch input to generate coordinate information corresponding to the touch input. The electronic whiteboard transmits the coordinate information to the electronic device. The electronic device receiving the coordinate information determines whether the coordinate information is located in the functional area of the electronic whiteboard. When the coordinate information is located in the functional area of the electronic whiteboard, the electronic device executes a function corresponding to the coordinate information. Alternatively, when the coordinate information is located outside the functional area of the electronic whiteboard, the electronic device displays the touch input corresponding to the coordinate information on the display.

In order to achieve one or a portion of or all of the objects or other objects, an embodiment of the invention provides an electronic whiteboard coupled to an electronic device having a display. The electronic whiteboard includes a functional area. The electronic whiteboard receives a touch input to generate coordinate information corresponding to the touch input. The electronic whiteboard determines whether the coordinate information is located in the functional area of the electronic whiteboard. When the coordinate information is located in the functional area of the electronic whiteboard, the electronic whiteboard transmits a command corresponding to the coordinate information to the electronic device, and the electronic device receiving the command executes a function corresponding to the command. Alternatively, when the coordinate information is located outside the functional area of the electronic whiteboard, the electronic whiteboard transmits the coordinate information to the electronic device, and the electronic device receiving the coordinate information displays the touch input corresponding to the coordinate information on the display.

Based on the above description, the embodiments of the invention can be adapted to determine whether the touch input is located in the functional area of the electronic whiteboard. When the touch input is located in the functional area, the electronic device executes the corresponding function. When the touch input is located outside the functional area, the electronic device directly displays the touch input on the display. Through the electronic whiteboard system, the operating method thereof and the electronic whiteboard of the invention, convenience and functionality of the electronic whiteboard are improved.

In order to make the aforementioned and other features and advantages of the invention comprehensible, several exemplary embodiments accompanied with figures are described in detail below.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an electronic whiteboard system according to an embodiment of the invention.

FIG. 2 is a flowchart illustrating an operating method of an electronic whiteboard system according to an embodiment of the invention.

FIG. 3 is a flowchart illustrating an operating method of an electronic whiteboard system according to another embodiment of the invention.

FIG. 4 is a schematic diagram of a functional area of an electronic whiteboard according to an embodiment of the invention.

FIG. 5 is a schematic diagram of a functional area of an electronic whiteboard according to another embodiment of the invention.

FIG. 6 is a schematic diagram of an application program corresponding to an electronic whiteboard displayed on the electronic device according to an embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

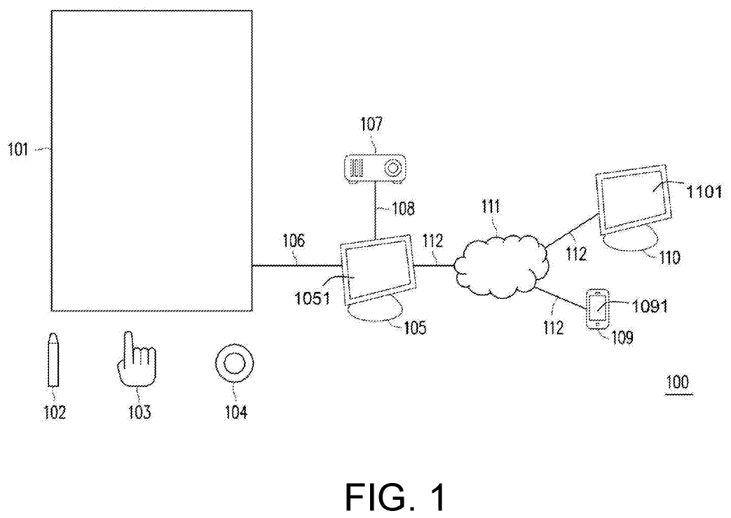

FIG. 1 is a schematic diagram of an electronic whiteboard system according to an embodiment of the invention.

Referring to FIG. 1, the electronic whiteboard system 100 of the invention includes an electronic whiteboard 101 and an electronic device 105. The electronic whiteboard 101 is, for example, a capacitive touch panel. The electronic whiteboard 101 can be provided for a user to write with a writing device 102. In an embodiment, the writing device 102 is, for example, a pen with electrical conductivity, or a stylus. If the writing device 102 is the pen with electrical conductivity, the writing device 102 may generate a physical handwriting on the electronic whiteboard 101, and generate a digital handwriting on the electronic device 105. A finger 103 may be used for wiping off the physical handwriting on the electronic whiteboard 101, and erasing the digital handwriting generated on the electronic device 105. An eraser 104 may be used for wiping off the physical handwriting on the electronic whiteboard 101, and erasing the digital handwriting generated on the electronic device 105. To be specific, the handwriting on the electronic whiteboard 101 may be transmitted to the electronic device 105 through a wired or wireless transmission 106 and synchronously displayed on the display 1051 of the electronic device 105. Moreover, when the handwriting on the electronic whiteboard 101 is erased by a touch input of the finger 103 or the eraser 104, the touch input of the finger 103 or the eraser 104 may be transmitted to the electronic device 105 through the wired or wireless transmission 106 to synchronously erase the corresponding digital handwriting on the electronic device 105. The electronic device 105 is, for example, any portable or non-portable electronic device, for example, a smart phone, a desktop computer, a notebook computer, a tablet PC, etc. A display image of the electronic device 105 may also be transmitted to a projector 107 through a wired or wireless transmission 108, and then be projected to a projection screen.

The electronic whiteboard 101, for example, further includes a first processor (not shown). The first processor may receive a touch input formed on the electronic whiteboard 101 by the writing device 102, the finger 103 and the eraser 104 and decode the touch input to generate coordinate information corresponding to the touch input.

The electronic device 105 may further include a second processor (not shown) and a storage device (not shown), the second processor is connected to the storage device, and the storage device may include an application program (not shown), and the application program is, for example, software. The second processor may receive a signal transmitted by the electronic whiteboard 101, and the second processor drives the application program in the storage device to perform signal processing according to the received signal. In other words, the electronic device 105 may include the application program corresponding to the electronic whiteboard 101. Moreover, the second processor and the storage device may be respectively different devices or may be integrated in one device, which is not limited by the invention.

The first processor of the electronic whiteboard 101 and the second processor of the electronic device 105 are, for example, Central Processing Units (CPUs), or other programmable general purpose or special purpose microprocessors, Digital Signal Processors (DSPs), programmable controllers, Application Specific Integrated Circuits (ASIC), Programmable Logic Devices (PLDs) or other similar devices or a combination of the above devices.

The storage device of the electronic device 105 is, for example, any type of a fixed or movable Random Access Memory (RAM), a Read-Only Memory (ROM), a flash memory or a similar device or a combination of the above device. The storage device of the electronic device 105 is configured to store a plurality of modules and related data, for example, the aforementioned application program corresponding to the electronic whiteboard 101, such that the electronic device 105 may execute the aforementioned application program corresponding to the electronic whiteboard 101 to implement the function of each embodiment of the invention.

In an embodiment, the display image of the electronic device 105 may also be transmitted to a network 111 through a wired or wireless transmission 112 and further transmitted to an electronic device 109 and an electronic device 110 connected to the network 111 through the wired or wireless transmission 112 for displaying on a display 1091 of the electronic device 109 and a display 1101 of the electronic device 110.

It should be noted that in FIG. 1, the electronic whiteboard 101 is coupled to one electronic device 105 through the wired or wireless transmission 106, though the invention is not limited thereto. In another embodiment, the electronic whiteboard 101 may also be coupled to a plurality of electronic devices through the wired or wireless transmission 106.

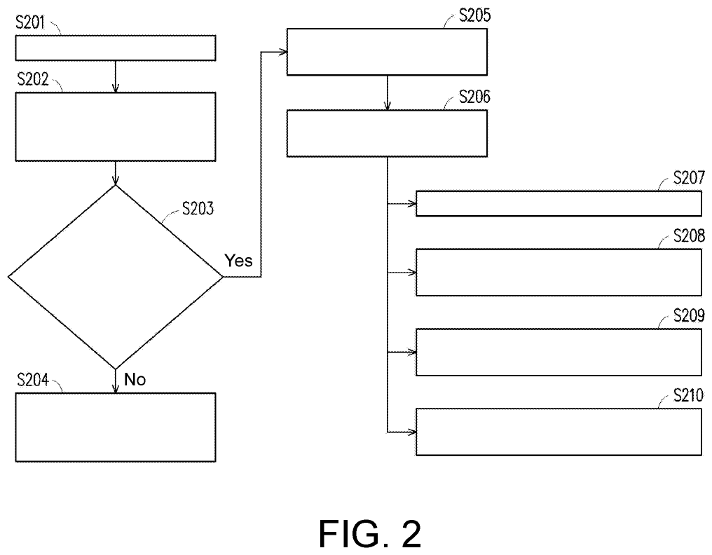

FIG. 2 is a flowchart illustrating an operating method of an electronic whiteboard system according to an embodiment of the invention.

Referring to FIG. 2, in step S201, the electronic whiteboard 101 receives a touch input of a user. The touch input is transmitted in a manner of electric signal. To be specific, the first processor of the electronic whiteboard 101 receives the touch input formed on the electronic whiteboard 101 through using the writing device 102 by the user.

In step S202, the electronic whiteboard 101 decodes the touch input to generate coordinate information corresponding to the touch input, and transmits the coordinate information to the electronic device 105. To be specific, the operation of decoding the touch input to generate coordinate information may also be executed by the first processor of the electronic whiteboard 101.

In step S203, the electronic device 105 receives the coordinate information and determines whether the coordinate information is located in a functional area of the electronic whiteboard 101. To be specific, the second processor of the electronic device 105 may receive the coordinate information transmitted by the electronic whiteboard 101, as described above, the storage device connected to the second processor in the electronic device 105 includes the application program corresponding to the electronic whiteboard 101, and the second processor may drive the application program corresponding to the electronic whiteboard 101 in the electronic device 105 according to the received coordinate information to determine the coordinate information. Further, the application program corresponding to the electronic whiteboard 101 may include a mapping table recording the coordinate information of the functional area and the corresponding functions. Therefore, by checking the mapping table, the function corresponding to the coordinate information in the functional area may be obtained.

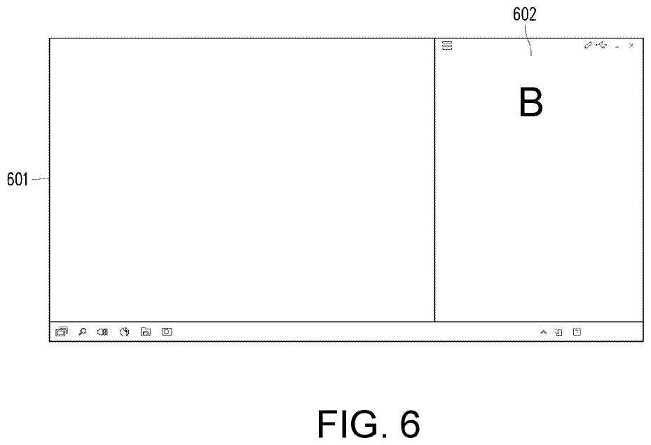

If not, the coordinate information is located outside the functional area, and in step S204, the electronic device 105 displays the touch input corresponding to the coordinate information on the display 1051 of the electronic device 105. To be specific, the application program corresponding to the electronic whiteboard 101 in the electronic device 105 may display the touch input corresponding to the coordinate information on the display 1051 of the electronic device 105. The touch input is, for example, any information input by the user such as a dot, a line segment, etc. For example, the display 1051 is, for example, a display 601 of FIG. 6. On the display 601, a window 602 of the application program corresponding to the electronic whiteboard 101 may display a handwriting based on the touch input corresponding to the handwriting, as that described later.

If yes, the coordinate information is located in the functional area of the electronic whiteboard 101, and in step S205, the application program corresponding to the electronic whiteboard 101 in the electronic device 105 inquires a function corresponding to the coordinate information. Then, in step S206, the application program corresponding to the electronic whiteboard 101 in the electronic device 105 executes the function corresponding to the coordinate information. The steps S207, S208, S209 and S210 are respectively exemplary functions corresponding to the coordinate information.

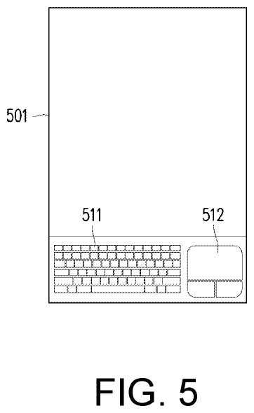

In step S207, the electronic whiteboard 101 transmits a single-key event or a mouse event to the electronic device 105. To be specific, the functional area of the electronic whiteboard 101 may include a keyboard region and a touch panel region. When the coordinate information is located in the keyboard region of the functional area, to be specific, when the user clicks any key (for example, A) in the keyboard region, the electronic whiteboard 101 may transmit the single-key event corresponding to such key to the electronic device 105, and the electronic device 105 generates the single-key event corresponding to the key to, for example, simulate an operation of the user clicking “A” on the keyboard of the electronic device 105. Similarly, when the user click a “left key region” or a “right key region” of the touch panel region, or scrolls on a “scroll region” of the touch panel region, the electronic whiteboard 101 transmits a “left key event”, a “right key event” or a “scroll event” corresponding to the mouse to the electronic device 105, such that the electronic device 105 generates the “left key event”, the “right key event” or the “scroll event” corresponding to the mouse to simulate an operation of the user of “clicking the left key”, “clicking the right key”, or “scrolling the mouse” on the mouse of the electronic device 105. For example, the electronic whiteboard 101 is now, for example, an electronic whiteboard 501 of FIG. 5, and the electronic whiteboard 501 may include a functional area 510, and the functional area 510 may further include a keyboard region 511 and a touch panel region 512, as that described later.

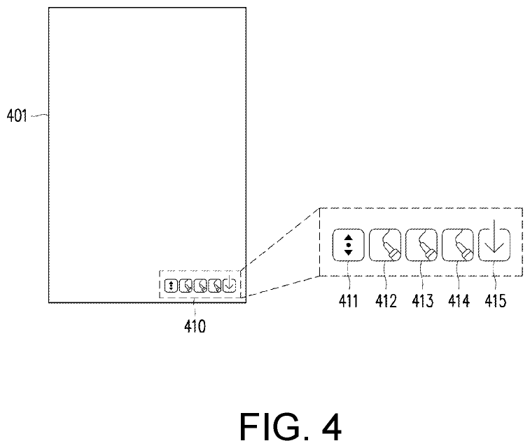

In step S208, when the coordinate information is located in one of a plurality of color regions of the functional area, the electronic device 105 changes a color of the touch input to display a next touch input located outside the functional area in the color corresponding to one of the color regions. For example, the functional area of the electronic whiteboard 101 may include a plurality of color regions, and the color regions respectively correspond to different colors, for example, red, blue, black. After the user click a region in the color regions corresponding to the red color, the application program corresponding to the electronic whiteboard 101 in the electronic device 105 displays all of the touch inputs corresponding to the coordinate information located outside the functional area in the red color. For example, the electronic whiteboard 101 is now, for example, an electronic whiteboard 401 of FIG. 4, and the electronic whiteboard 401 may include a functional area 410, and the functional area 410 may further include color regions 412-414, as that described later. In an embodiment, besides changing the color of the touch input, the functional area may further provide functions such as changing a handwriting thickness, a font size, a font type, etc. In step S209, when the coordinate information is located in a switching region of the functional area, the electronic device 105 may switch the window between a full screen mode and a non-full screen mode. To be specific, under the non-full screen mode, the application program corresponding to the electronic whiteboard 101 in the electronic device 105 may make the window of the display 1051 to display at a part of region of the display 1051. Under the full-screen mode, the application program corresponding to the electronic whiteboard 101 in the electronic device 105 may make a display width of the window of the display 1051 to extend to a whole display width of the display 1051. For example, the electronic whiteboard 101 is now, for example, the electronic whiteboard 401 of FIG. 4, and the electronic whiteboard 401 may include the functional area 410, and the functional area 410 may further include a switching region 411, as that described later.

In step S210, when the coordinate information is located at a file saving region of the functional area, the electronic device 105 executes a file saving operation. For example, the application program corresponding to the electronic whiteboard 101 in the electronic device 105 may save a current image in the window of the display 1051 as a picture file, though the invention is not limited thereto. For example, the electronic whiteboard 101 is now, for example, the electronic whiteboard 401 of FIG. 4, and the electronic whiteboard 401 may include the functional area 410, and the functional area 410 may further include a file saving region 415, as that described later.

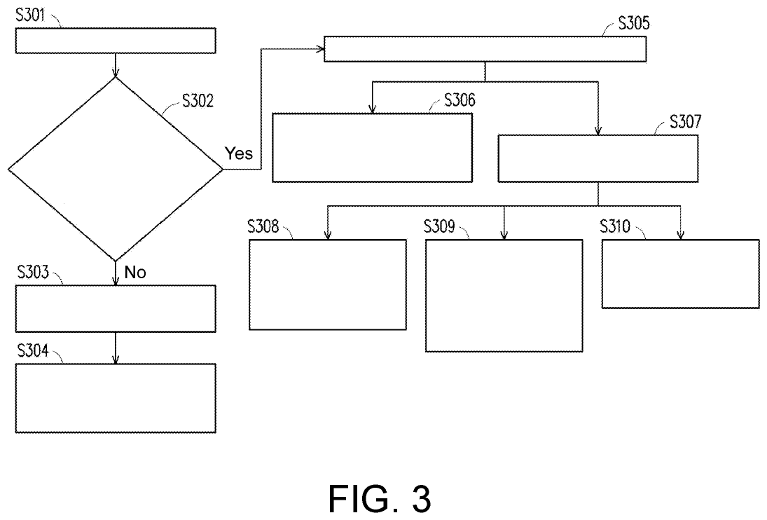

FIG. 3 is a flowchart illustrating an operating method of an electronic whiteboard system according to another embodiment of the invention.

Referring to FIG. 3, in step S301, the electronic whiteboard 101 receives a touch input of a user. The touch input is transmitted in a manner of electric signal. To be specific, the first processor of the electronic whiteboard 101 receives the touch input formed on the electronic whiteboard 101 through using the writing device 102 by the user.

In step S302, the electronic whiteboard 101 decodes the touch input to generate coordinate information corresponding to the touch input, and determines whether the coordinate information is located in the functional area of the electronic whiteboard 101. To be specific, the operations of decoding the touch input to generate coordinate information and determining the coordinate information may also be executed by the first processor of the electronic whiteboard 101. Further, the first processor of the electronic whiteboard 101 may include a mapping table recording the coordinate information of the functional area and the corresponding functions, so that by checking the mapping table, the function corresponding to the coordinate information in the functional area may be obtained.

If not, the coordinate information is located outside the functional area, and in step S303, the electronic whiteboard 101 transmits the coordinate information to the electronic device 105. Then, in step S304, the electronic device 105 receives the coordinate information and displays the touch input corresponding to the coordinate information on the display 1051. To be specific, the application program corresponding to the electronic whiteboard 101 in the electronic device 105 may display the touch input corresponding to the coordinate information on the display 1051 of the electronic device 105. The touch input is, for example, any information input by the user such as a dot, a line segment, etc. For example, the display 1051 is, for example, the display 601 of FIG. 6. On the display 601, the window 602 of the application program corresponding to the electronic whiteboard 101 may display a handwriting based on the touch input corresponding to the handwriting, as that described later.

If yes, the coordinate information is located in the functional area of the electronic whiteboard 101, and in step S305, the electronic whiteboard 101 inquires a function corresponding to the coordinate information.

Then, in step S306, when the coordinate information is located in the keyboard region or the touch panel region of the functional area, the electronic whiteboard 101 transmits a single-key event or a mouse event to the electronic device 105. To be specific, the functional area of the electronic whiteboard 101 may include the keyboard region, and when the electronic whiteboard 101 is coupled to the electronic device 105, the electronic whiteboard 101 transmits a device adding event to the electronic device 105 for the electronic device 105 to add a keyboard device. Moreover, the functional area of the electronic whiteboard 101 may include the touch panel region, and when the electronic whiteboard 101 is coupled to the electronic device 105, the electronic whiteboard 101 transmits another device adding event to the electronic device 105 for the electronic device 105 to add a mouse device. The above device adding operation may be executed by a device manager of the electronic device 105. Through the device adding process, it is equivalent to couple a physical keyboard and a physical mouse to the electronic device 105. Therefore, when the user clicks any key (for example, A) in the keyboard region, the electronic whiteboard 101 may transmit a single-key event corresponding to such key to the electronic device 105. Similarly, when the user click the “left key region” or the “right key region” of the touch panel region, or scrolls on the “scroll region” of the touch panel region, the electronic whiteboard 101 transmits the “left key event”, the “right key event” or the “scroll event” corresponding to the mouse to the electronic device 105. For example, the electronic whiteboard 101 is now, for example, the electronic whiteboard 501 of FIG. 5, and the electronic whiteboard 501 may include the functional area 510, and the functional area 510 may further include the keyboard region 511 and the touch panel region 512, as that described later.

Moreover, when the coordinate information is not located in the keyboard region or the touch panel region of the functional area but is located in other region of the functional area, a step S307 is executed. In the step S307, the electronic whiteboard 101 transmits a command corresponding to the coordinate information to the electronic device 105. To be specific, the first processor of the electronic whiteboard 101 may transmit the command corresponding to the coordinate information to the second processor of the electronic device 105, and the second processor of the electronic device 105 that receives the command may drive the application program corresponding to the electronic whiteboard 101 in the electronic device 105 to execute a function corresponding to the command according to the received command corresponding to the coordinate information. Steps S308, S309 and S310 are respectively exemplary commands corresponding to the coordinate information and exemplary functions.

In step S308, when the coordinate information is located in one of a plurality of color regions of the functional area, the electronic whiteboard 101 transmits a color changing command to the electronic device 105, such that the electronic device 105 changes a color of the touch input to display a next touch input located outside the functional area in the color corresponding to one of the color regions. For example, the functional area of the electronic whiteboard 101 may include a plurality of color regions, and the color regions respectively correspond to different colors, for example, red, blue, black. After the user click a region in the color regions corresponding to the red color, the application program corresponding to the electronic whiteboard 101 in the electronic device 105 displays all of the touch inputs corresponding to the coordinate information located outside the functional area in the red color. For example, the electronic whiteboard 101 is now, for example, the electronic whiteboard 401 of FIG. 4, and the electronic whiteboard 401 may include the functional area 410, and the functional area 410 may further include color regions 412-414, as that described later. In an embodiment, besides changing the color of the touch input, the functional area may further provide functions such as changing a handwriting thickness, a font size, a font type, etc.

In step S309, when the coordinate information is located in a switching region of the functional area, the electronic device 105 may switch the window between a full screen mode and a non-full screen mode. To be specific, under the non-full screen mode, the application program corresponding to the electronic whiteboard 101 in the electronic device 105 may make the window of the display 1051 to display at a part of region of the display 1051. Under the full-screen mode, the application program corresponding to the electronic whiteboard 101 in the electronic device 105 may make a display width of the window of the display 1051 to extend to a whole display width of the display 1051. For example, the electronic whiteboard 101 is now, for example, the electronic whiteboard 401 of FIG. 4, and the electronic whiteboard 401 may include the functional area 410, and the functional area 410 may further include the switching region 411, as that described later.

In step S310, when the coordinate information is located at a file saving region of the functional area, the electronic device 105 executes a file saving operation. For example, the application program corresponding to the electronic whiteboard 101 in the electronic device 105 may save a current image in the window of the display 1051 as a picture file, though the invention is not limited thereto. For example, the electronic whiteboard 101 is now, for example, the electronic whiteboard 401 of FIG. 4, and the electronic whiteboard 401 may include the functional area 410, and the functional area 410 may further include a file saving region 415, as that described later.

FIG. 4 is a schematic diagram of a functional area of an electronic whiteboard according to an embodiment of the invention.

Referring to FIG. 4, the electronic whiteboard 401 of the invention may include the functional area 410. The functional area 410 may further include the switching region 411, the color regions 412-414 and the file saving region 415. For example, the color regions 412-414 may respectively correspond to the red color, the blue color and the black color. Each of the switching region 411, the color regions 412-414 and the file saving region 415 may be regarded as a different hotkey. The corresponding function is executed as long as the user clicks the hotkey.

FIG. 5 is a schematic diagram of a functional area of an electronic whiteboard according to another embodiment of the invention.

Referring to FIG. 5, the electronic whiteboard 501 of the invention may include the functional area 510. The functional area 510 may further include the keyboard region 511 and the touch panel region 512. The user may click the keyboard region 511 to execute a keyboard function. The user may also click a left key region or a right key region of the touch panel region 512 to execute the left key function or the right key function of the mouse, or scroll a scroll region of the touch panel region 512 to execute the scroll function of the mouse.

FIG. 6 is a schematic diagram of an application program corresponding to an electronic whiteboard displayed on the electronic device according to an embodiment of the invention.

Referring to FIG. 6, when the user writes a character “B” outside the functional area of the electronic whiteboard 101, the window 602 of the application program corresponding to the electronic whiteboard 101 may be displayed on the display 601 of the electronic device 105, and the window 602 may display the character “B”.

In summary, the aforementioned embodiments of the invention can be adapted to determine whether the touch input is located in the functional area of the electronic whiteboard. When the touch input is located in the functional area, the electronic device executes the corresponding function. When the touch input is located outside the functional area, the electronic device directly displays the touch input on the display. The functional area may include a keyboard mouse function, a full screen switching function, a color changing function and a file saving function. Through the electronic whiteboard system, the operating method thereof and the electronic whiteboard of the invention, convenience and functionality of the electronic whiteboard are improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An electronic whiteboard system, comprising:
an electronic whiteboard, comprising a functional area; and
an electronic device, coupled to the electronic whiteboard, and comprising a display, wherein
the electronic whiteboard receives a touch input to generate coordinate information corresponding to the touch input,
the electronic whiteboard transmits the coordinate information to the electronic device,
the electronic device receiving the coordinate information determines whether the coordinate information is located in the functional area of the electronic whiteboard, and
when the coordinate information is located in the functional area of the electronic whiteboard, the electronic device executes a function corresponding to the coordinate information, alternatively, when the coordinate information is located outside the functional area of the electronic whiteboard, the electronic device displays the touch input corresponding to the coordinate information on the display.

2. The electronic whiteboard system as claimed in claim 1, wherein the functional area comprises a keyboard region, and when the electronic device determines that the coordinate information is located in the keyboard region, the electronic device generates a single-key event corresponding to the coordinate information.

3. The electronic whiteboard system as claimed in claim 1, wherein the functional area comprises a touch panel region, and when the electronic device determines that the coordinate information is located in the touch panel region, the electronic device generates a mouse event corresponding to the coordinate information, and the mouse event comprises a scroll event, a left key event and a right key event.

4. The electronic whiteboard system as claimed in claim 1, wherein the functional area comprises a plurality of color regions, and when the electronic device determines that the coordinate information is located in one of the plurality of color regions, the electronic device displays a next touch input located outside the functional area in a color corresponding to one of the plurality of color regions.

5. The electronic whiteboard system as claimed in claim 1, wherein the functional area comprises a switching region, and when the electronic device determines that the coordinate information is located in the switching region, the electronic device switches a window between a full screen mode and a non-full screen mode.

6. The electronic whiteboard system as claimed in claim 1, wherein the functional area comprises a file saving region, and when the electronic device determines that the coordinate information is located in the file saving region, the electronic device executes a file saving operation.

7. An electronic whiteboard system, comprising:
an electronic whiteboard, comprising a functional area; and
an electronic device, coupled to the electronic whiteboard, and comprising a display, wherein
the electronic whiteboard receives a touch input to generate coordinate information corresponding to the touch input,
the electronic whiteboard determines whether the coordinate information is located in the functional area of the electronic whiteboard, and
when the coordinate information is located in the functional area of the electronic whiteboard, the electronic whiteboard transmits a command corresponding to the coordinate information to the electronic device, and the electronic device receiving the command executes a function corresponding to the command, alternatively, when the coordinate information is located outside the functional area of the electronic whiteboard, the electronic whiteboard transmits the coordinate information to the electronic device, and the electronic device receiving the coordinate information displays the touch input corresponding to the coordinate information on the display.

8. The electronic whiteboard system as claimed in claim 7, wherein the functional area comprises a keyboard region, wherein when the electronic whiteboard is coupled to the electronic device, the electronic whiteboard transmits a device adding event to the electronic device for the electronic device to add a keyboard device, wherein when the electronic whiteboard determines that the coordinate information is located in the keyboard region, the electronic whiteboard transmits a single-key event corresponding to the coordinate information to the electronic device.

9. The electronic whiteboard system as claimed in claim 7, wherein the functional area comprises a touch panel region, wherein when the electronic whiteboard is coupled to the electronic device, the electronic whiteboard transmits a device adding event to the electronic device for the electronic device to add a mouse device, wherein when the electronic whiteboard determines that the coordinate information is located in the touch panel region, the electronic whiteboard transmits a mouse event corresponding to the coordinate information to the electronic device, and the mouse event comprises a scroll event, a left key event and a right key event.

10. The electronic whiteboard system as claimed in claim 7, wherein the functional area comprises a plurality of color regions, wherein when the electronic whiteboard determines that the coordinate information is located in one of the plurality of color regions, the electronic whiteboard transmits a color changing command to the electronic device for the electronic device to display a next touch input located outside the functional area in a color corresponding to one of the plurality of color regions.

11. The electronic whiteboard system as claimed in claim 7, wherein functional area comprises a switching region, wherein when the electronic whiteboard determines that the coordinate information is located in the switching region, the electronic whiteboard transmits a switching command to the electronic device for the electronic device to switch a window between a full screen mode and a non-full screen mode.

12. The electronic whiteboard system as claimed in claim 7, wherein the functional area comprises a file saving region, wherein when the electronic whiteboard determines that the coordinate information is located in the file saving region, the electronic whiteboard transmits a file saving command to the electronic device for the electronic device to execute a file saving operation.

13. An operating method, comprising:
receiving a touch input by an electronic whiteboard and generating coordinate information corresponding to the touch input;
transmitting the coordinate information to an electronic device by the electronic whiteboard;
determining whether the coordinate information is located in a functional area of the electronic whiteboard by the electronic device receiving the coordinate information; and
when the coordinate information is located in the functional area of the electronic whiteboard, executing a function corresponding to the coordinate information by the electronic device, or when the coordinate information is located outside the functional area of the electronic whiteboard, displaying the touch input corresponding to the coordinate information on a display by the electronic device.

14. The operating method as claimed in claim 13, wherein the functional area comprises a keyboard region, and when the electronic device determines that the coordinate information is located in the keyboard region, the electronic device generates a single-key event corresponding to the coordinate information.

15. The operating method as claimed in claim 13, wherein the functional area comprises a touch panel region, and when the electronic device determines that the coordinate information is located in the touch panel region, the electronic device generates a mouse event corresponding to the coordinate information, and the mouse event comprises a scroll event, a left key event and a right key event.

16. The operating method as claimed in claim 13, wherein the functional area comprises a plurality of color regions, and when the electronic device determines that the coordinate information is located in one of the plurality of color regions, the electronic device displays a next touch input located outside the functional area in a color corresponding to one of the plurality of color regions.

17. The operating method as claimed in claim 1, wherein the functional area comprises a switching region, and when the electronic device determines that the coordinate information is located in the switching region, the electronic device switches a window between a full screen mode and a non-full screen mode.

18. The operating method as claimed in claim 13, wherein the functional area comprises a file saving region, and when the electronic device determines that the coordinate information is located in the file saving region, the electronic device executes a file saving operation.

19. An operating method, comprising:
receiving a touch input by an electronic whiteboard and generating coordinate information corresponding to the touch input;
determining whether the coordinate information is located in a functional area of the electronic whiteboard by the electronic whiteboard; and
when the coordinate information is located in the functional area of the electronic whiteboard, transmitting a command corresponding to the coordinate information to the electronic device by the electronic whiteboard, and executing a function corresponding to the command by the electronic device receiving the command, or when the coordinate information is located outside the functional area of the electronic whiteboard, transmitting the coordinate information to the electronic device by the electronic whiteboard, and displaying the touch input corresponding to the coordinate information on a display by the electronic device receiving the coordinate information.

20. The operating method as claimed in claim 19, wherein the functional area comprises a keyboard region, wherein when the electronic whiteboard is coupled to the electronic device, the electronic whiteboard transmits a device adding event to the electronic device for the electronic device to add a keyboard device, wherein when the electronic whiteboard determines that the coordinate information is located in the keyboard region, the electronic whiteboard transmits a single-key event corresponding to the coordinate information to the electronic device.

21. The operating method as claimed in claim 19, wherein the functional area comprises a touch panel region, wherein when the electronic whiteboard is coupled to the electronic device, the electronic whiteboard transmits a device adding event to the electronic device for the electronic device to add a mouse device, wherein when the electronic whiteboard determines that the coordinate information is located in the touch panel region, the electronic whiteboard transmits a mouse event corresponding to the coordinate information to the electronic device, and the mouse event comprises a scroll event, a left key event and a right key event.

22. The operating method as claimed in claim 19, wherein the functional area comprises a plurality of color regions, wherein when the electronic whiteboard determines that the coordinate information is located in one of the plurality of color regions, the electronic whiteboard transmits a color changing command to the electronic device for the electronic device to display a next touch input located outside the functional area in a color corresponding to one of the plurality of color regions.

23. The operating method as claimed in claim 19, wherein functional area comprises a switching region, wherein when the electronic whiteboard determines that the coordinate information is located in the switching region, the electronic whiteboard transmits a switching command to the electronic device for the electronic device to switch a window between a full screen mode and a non-full screen mode.

24. The operating method as claimed in claim 19, wherein the functional area comprises a file saving region, wherein when the electronic whiteboard determines that the coordinate information is located in the file saving region, the electronic whiteboard transmits a file saving command to the electronic device for the electronic device to execute a file saving operation.

25. An electronic whiteboard, coupled to an electronic device having a display, the electronic whiteboard comprising a functional area, wherein
the electronic whiteboard receives a touch input to generate coordinate information corresponding to the touch input, the electronic whiteboard transmits the coordinate information to the electronic device, and the electronic device receiving the coordinate information determines whether the coordinate information is located in the functional area of the electronic whiteboard,
when the coordinate information is located in the functional area of the electronic whiteboard, the electronic device executes a function corresponding to the coordinate information, alternatively, when the coordinate information is located outside the functional area of the electronic whiteboard, the electronic device displays the touch input corresponding to the coordinate information on the display.

26. The electronic whiteboard as claimed in claim 25, wherein the functional area comprises a keyboard region, and when the electronic device determines that the coordinate information is located in the keyboard region, the electronic device generates a single-key event corresponding to the coordinate information.

27. The electronic whiteboard as claimed in claim 25, wherein the functional area comprises a touch panel region, and when the electronic device determines that the coordinate information is located in the touch panel region, the electronic device generates a mouse event corresponding to the coordinate information, and the mouse event comprises a scroll event, a left key event and a right key event.

28. The electronic whiteboard as claimed in claim 25, wherein the functional area comprises a plurality of color regions, and when the electronic device determines that the coordinate information is located in one of the plurality of color regions, the electronic device displays a next touch input located outside the functional area in a color corresponding to one of the plurality of color regions.

29. The electronic whiteboard as claimed in claim 25, wherein the functional area comprises a switching region, and when the electronic device determines that the coordinate information is located in the switching region, the electronic device switches a window between a full screen mode and a non-full screen mode.

30. The electronic whiteboard as claimed in claim 25, wherein the functional area comprises a file saving region, and when the electronic device determines that the coordinate information is located in the file saving region, the electronic device executes a file saving operation.

31. An electronic whiteboard, coupled to an electronic device having a display, the electronic whiteboard comprising: a functional area, wherein
the electronic whiteboard receives a touch input to generate coordinate information corresponding to the touch input, and the electronic whiteboard determines whether the coordinate information is located in the functional area of the electronic whiteboard,
when the coordinate information is located in the functional area of the electronic whiteboard, the electronic whiteboard transmits a command corresponding to the coordinate information to the electronic device, and the electronic device receiving the command executes a function corresponding to the command, alternatively, when the coordinate information is located outside the functional area of the electronic whiteboard, the electronic whiteboard transmits the coordinate information to the electronic device, and the electronic device receiving the coordinate information displays the touch input corresponding to the coordinate information on the display.

32. The electronic whiteboard as claimed in claim 31, wherein the functional area comprises a keyboard region, wherein when the electronic whiteboard is coupled to the electronic device, the electronic whiteboard transmits a device adding event to the electronic device for the electronic device to add a keyboard device, wherein when the electronic whiteboard determines that the coordinate information is located in the keyboard region, the electronic whiteboard transmits a single-key event corresponding to the coordinate information to the electronic device.

33. The electronic whiteboard as claimed in claim 31, wherein the functional area comprises a touch panel region, wherein when the electronic whiteboard is coupled to the electronic device, the electronic whiteboard transmits a device adding event to the electronic device for the electronic device to add a mouse device, wherein when the electronic whiteboard determines that the coordinate information is located in the touch panel region, the electronic whiteboard transmits a mouse event corresponding to the coordinate information to the electronic device, and the mouse event comprises a scroll event, a left key event and a right key event.

34. The electronic whiteboard as claimed in claim 31, wherein the functional area comprises a plurality of color regions, wherein when the electronic whiteboard determines that the coordinate information is located in one of the plurality of color regions, the electronic whiteboard transmits a color changing command to the electronic device for the electronic device to display a next touch input located outside the functional area in a color corresponding to one of the plurality of color regions.

35. The electronic whiteboard as claimed in claim 31, wherein functional area comprises a switching region, wherein when the electronic whiteboard determines that the coordinate information is located in the switching region, the electronic whiteboard transmits a switching command to the electronic device for the electronic device to switch a window between a full screen mode and a non-full screen mode.

36. The electronic whiteboard as claimed in claim 31, wherein the functional area comprises a file saving region, wherein when the electronic whiteboard determines that the coordinate information is located in the file saving region, the electronic whiteboard transmits a file saving command to the electronic device for the electronic device to execute a file saving operation.
